(19) United States
(12) Patent Application Publication
(10) Pub. No.: US 2009/0252572 A1
(43) Pub. Date: Oct. 8, 2009

(54) SCREW, BOLT OR LOCKING RING BOLT

(75) Inventor: Robert Kupczyk, Viersen (DE)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: ACUMENT GMBH & CO. OHG, Neuwied (DE)

(21) Appl. No.: 12/375,509

(22) PCT Filed: Aug. 1, 2007
(86) PCT No.: PCT/DE07/01368

§ 371 Date: Mar. 5, 2009

(30) Foreign Application Priority Data
Aug. 4, 2006 (DE) 20 2006 011 950.7

(51) Int. Cl. F16B 39/00; B21H 3/02

(52) U.S. Cl. 411/217; 470/9

(57) ABSTRACT

Screw (10), bolt or locking ring bolt (20), each exclusively produced by rolling as well as a method of production of such a screw (10), such a bolt or such a locking ring bolt (20).

The present invention relates to a screw, a bolt or a locking ring bolt. Regarding these products worldwide there is a substantial competition. The prices of these products therefore are extremely low and it is therefore the task to be solved by the present invention to provide a screw, a bolt or a locking ring bolt which can be manufactured substantially less costly.

According to the prior art such fasteners as the above-mentioned screws, bolts or locking ring bolts since more than a 100 years are manufactured by pressing (cold forming operations). This procedure until now was the cheapest possibility for manufacturing these products. Merely for the threads of screws or bolts rolling was used as a manufacturing procedure.

Starting out from this prior art according to the invention, for the first time, it was realized that it is possible to produce screws, bolts or locking ring bolts exclusively by rolling in a single manufacturing step. In this connection, the screw, the bolt or the locking ring bolt can be produced by a single manufacturing step of rolling, wherein a corresponding exterior force application point, too, as for example a hexagonal, a hexalobular (hex-round) force application point or an exterior multiple teeth force application point can be produced in the one single same manufacturing step of rolling.

According to the invention, even a flange can be rolled in connection with the screws or the bolts. According to the invention this rolling procedure even can be designed such that the screw or the bolt can be provided with a captured washer in the single production step. In this way, the screw according to the invention, the bolt according to the invention or the locking ring bolt can be rolled in one single production step completely with thread, force application point, flange or possibly washer attached in a captured way. If necessary, several rolling steps can be provided, too. In this way, the production of the screw according to the invention, of the bolt according to the invention or of the locking ring bolt can be substantially simplified and can be made substantially cheaper since the corresponding pressing or cold forming operations and the usual subsequently performed washing procedures can be dispensed with completely during the production of the fastener according to the invention.

In an advantageous way in connection with the production of a fastener according to the invention the method steps of dephosphatizing and of heat treatment can be dispensed with, too, as far as a steel is used the cold work hardening of which during the cold forming operation is sufficiently large to obtain the necessary strength values for the fastener according to the invention. For example for this purpose steels and production methods are suitable as these already are described in the German utility model 20 2005 015 611 U1.

In this way screws according to the invention, bolts or locking ring bolts can be manufactured with a singular manufacturing step, namely, by rolling. This kind of production then is the absolutely cheapest way for manufacturing such fasteners.

The inventive idea of the present invention is based on the fact to have realized that screws, bolts or locking ring bolts produced from suitable steels can be manufactured exclusively by rolling without any pressing operations being necessary.

Rolling methods according to the prior art exclusively were known for gears and for the exterior threads of screws.

The screws, bolts or locking ring bolts according to the invention directly can be produced by rolling from the raw wire after cutting the raw wire to a suitable length. Additionally a corresponding washer can be fed to the rolling machine in case such washer captively should be attached to the fastener.

The present invention is more detailly described with reference to exemplary embodiments shown in the drawings. In the drawings shows:

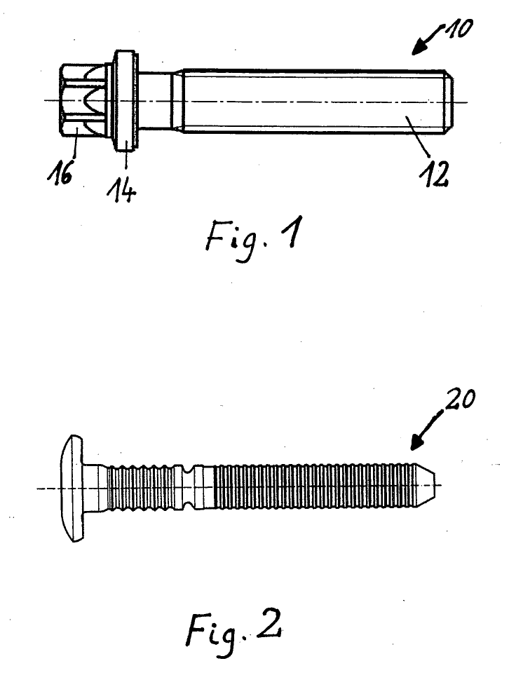

FIG. 1 a screw according to the invention and

FIG. 2 a locking ring bolt according to the invention.

FIG. 1 is showing a screw 10 according to the invention which completely is produced in a single production step of rolling from a section of wire of suitable length. In a singular rolling step the exterior thread 12, the flange 4 and the hexalobular (exterior hex-round) force application point 16 had been produced.

FIG. 2 is showing a locking ring bolt 20 which has been produced in a singular production step by rolling.

Both fasteners according to the invention here have been produced in a singular production step exclusively by rolling and the strength thereof exclusively is based on the cold work hardening during the forming operation. To this end, they are produced from a steel as for example described in the German utility model 20 2005 015 611 U1. Self-evidently other suitable steels, too, can be used.

1. Screw (10), bolt or locking ring bolt (20), characterized in that the same exclusively is produced by rolling.

2. Screw (10), bolt or locking ring bolt (20) according to claim 1, characterized in that the same is having a force application point (16), for example a hexagonal, hexalobular (hex-round) force application point or a force application point with multiple exterior teeth.

3. Screw (10), bolt or locking ring bolt (20) according to claim 1 or 2, characterized in that the strength of the same exclusively is based on the cold work hardening during the forming operation.

4. Screw (10), bolt or locking ring bolt (20) according to claim 1, 2 or 3, characterized in that the same during the rolling had been provided with a captured washer.

5. Screw (10) or bolt according to claim 1, 2 or 3, characterized in that a flange (14) is positioned between the force application point (16) and the bearer (12) of the thread.

6. A method for the production of a screw (10), a bolt or a locking ring bolt (20), characterized in that the method exclusively is comprising the working steps of rolling.

7. A method according to claim 6, characterized in that during the production an exterior force application point (16), for example a hexalobulaire (hexround) force application point or an exterior multiple teeth force application point is produced by rolling.

8. A method according to claim 5 or 6, characterized in that the strength of the screw (10) of the bolt or the locking ring bolt (20) exclusively is created by means of cold work hardening during the forming operation by rolling.

9. A method according to any of the claims 6, 7 or 8, characterized in that during the rolling procedure a washer captively is attached to the screw (10), the bolt or the locking ring bolt (20).

10. A method according to any of the claims 6, 7 or 8, characterized in that during the rolling procedures a flange (14) is produced between the force application point (16) and the bearer (12) of the thread.

11. A method according to any of the claims 6 to 10, characterized in that the screw (10), the bolt or the locking ring bolt (20) are directly produced exclusively by rolling from the raw wire after cutting the raw wire to a suitable length.
